(19) United States
(12) Patent Application Publication
(10) Pub. No.: US 2022/0026048 A1
(43) Pub. Date: Jan. 27, 2022

(54) System and Method for LED Pool Light

(71) Applicant: James Eric JOBE, Cleburne, TX (US)

(72) Inventor: James Eric JOBE, Cleburne, TX (US)

(21) Appl. No.: 17/382,012

(22) Filed: Jul. 21, 2021

Related U.S. Application Data
(60) Provisional application No. 63/054,494, filed on Jul. 21, 2020.

(51) Int. Cl. F21V 19/00; F21V 23/04

(52) U.S. Cl. CPC F21V 19/003; F21Y 2115/10; F21V 23/0435

(57) ABSTRACT

A system and method for a pool light. The system has a planar plate, and a niche coupled the plate. The system includes a wire and a light. The light couples to the niche. The system can run on direct current. The system can include an AC/DC converter to convert AC to DC.

### PRIORITY

The present invention claims priority to U.S. Provisional Application No. 63/054,494 filed Jul. 21, 2020, the entirety of both of which are hereby incorporated by reference.

### BACKGROUND OF THE INVENTION

### Technical Field

The present invention relates to a system and method for a pool light.

### Description of Related Art

Traditional pool lights usually utilize incandescent lights. These lights have significant disadvantages. Consequently, there is a need for a system and method which allows these lights to be replaced with a better system.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 shows a back-perspective view of the assembly in one embodiment;

FIG. 2 is a front perspective view of the assembly in one embodiment;

FIG. 3 shows a front perspective of the assembly with the light installed;

FIG. 4 is a perspective view of the converter and controller in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

Prior pool and water lights consisted of an incandescent light with a housing. In one embodiment of the system discussed herein the system does not use a housing but instead attaches to the niche such that there is no longer any need for a housing. In some embodiments, only 12 volts is presented to the niche and then to the light. This allows for elimination of the prior housing and results in a safer, and more adaptable and controllable light source.

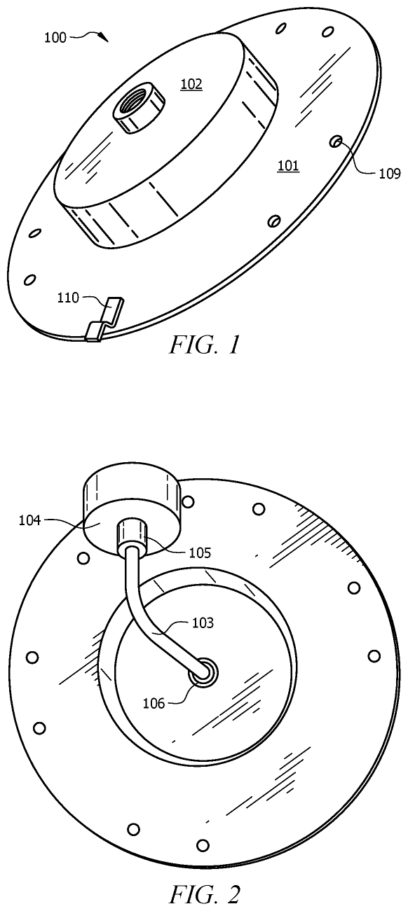

FIG. 1 shows a back-perspective view of the assembly 100 in one embodiment. As shown the assembly 100 has a planar plate 101 and an inner niche 102. The plate 101 is installed to cover a recess or void in the pool, hot tub, etc. for the light. While one embodiment is described in reference to a pool, this is for illustrative purposes only and should not be deemed limiting. The system can be used in any body of water, including a dock, a hot tub, pool, bath, etc. In one embodiment the assembly 100 is installed such that the light and plate 101 are flush with the adjacent walls of the pool.

The plate 101 has coupling holes 109 which are used to couple the plate 101 to the pool, for example. The pool will have a recess as well as matching holes. When the coupling holes 109 are aligned with the holes in the pool, the plate 101 can be secured to the pool. Note that while coupling holes 109 are shown, in other systems the assembly 100 can be coupled and mated with the pool in various other ways.

Coupled to the plate 101 is the niche 102. The niche 102, as depicted, extends backwards away from the planar surface of the plate 101. The niche 102 secures the light 104 in place. As shown, the niche 102 is not flush with the plate 101. This allows the light to be stored in the recess of the niche 102. The niche 102 can comprise a different material which is coupled to the plate 101, or the plate 101 and the niche 102 can be integrally made.

The niche 102 and the plate 101 can comprise virtually any material. They can include metal, plastic, and combinations thereof. In one embodiment the niche 102 and the plate 101 comprise a single piece of stainless steel.

In one embodiment, and as depicted, the back face of the planar plate 101 has a clip 110. The clip 110 is used to clip onto the existing pool niche to keep the assembly 100 in the desired location. In one embodiment the clip 110 goes in at an angle to the niche, and when the assembly 100 is tilted, the clip engages. While a clip 110 is shown, this is for illustrative purposes only and should not be deemed limiting. Virtually any mechanism which couples the assembly to the niche can be utilized. This includes mounts, screws, bolts, and the like.

FIG. 2 is a front perspective view of the assembly in one embodiment. As shown, the niche 102 has a hole therethrough. A wire 103 can extend through the hole in the niche 102 to attach the light 104. Virtually any light 104 can be utilized. In one embodiment an LED light is used. An LED light offers increased versatility compared to traditional incandescent lights. LED lights can often change color, strength, pattern, etc. Thus, coupling to an LED light gives the user increased flexibility. The size and strength of the light and LED can vary. In one embodiment the light 104 is a 100 Watt LED with approximately 8,000 lumens. In one embodiment the LED is an RGB LED. This is for illustrative purposes only and should not be limited.

An additional benefit of an LED light compared to incandescent lights is that an LED light consumes up to 50% less energy than incandescent 120 V pool lights.

The light 104 which houses the LED, in one embodiment is stainless steel. The LED is completely encapsulated, and the pool water keeps the light 104 cool.

As shown, the light 104 has a stem 105 which couples to the stem receiver 106 located on the niche 102. In this way, the light 104 can be coupled and secured to the niche 102. In one embodiment the stem 105 and stem receiver 106 comprise threads so they can threadingly couple to one another. In one embodiment, and as depicted, the wire 103 is stored and protected behind the niche 102. Having a stem 105 and stem receiver 106 allows the light 104 to be easily replaced. While LEDs last for a very long time, if one became damaged or stopped functioning, the light 104 can simply be unscrewed from the stem receiver and the light 104 can be replaced. This can be accomplished, in some embodiments, without removing the plate 101.

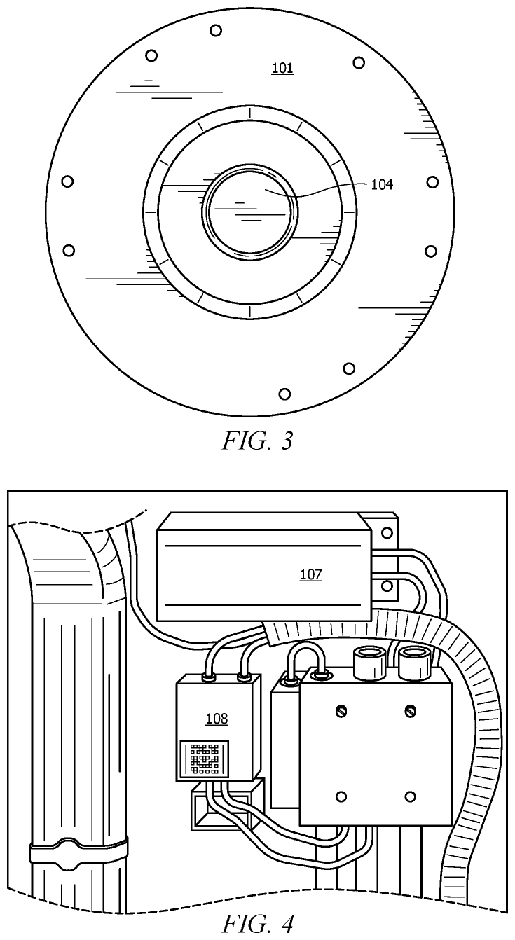

FIG. 3 shows a front perspective of the assembly 100 with the light 104 installed. As shown the light 104 is an LED light. As noted, in one embodiment the light 104 is below the planar surface of the plate 101. The light 104 can be exposed, or a protective cover can be placed atop the light 104.

As noted, in one embodiment the assembly does not include a housing. Accordingly, in one embodiment there is no separate external housing which covers the light 104. Further, while prior art lights often used alternating current (AC), in one embodiment the lights disclosed herein use direct current (DC). In one embodiment the lights 104 comprise LED lights which utilize 12 V DC low voltage. No AC is present within the assembly. This is a significant safety advantage. Low voltage is presented to the lights as opposed to potentially dangerous AC power. Because of this, the lights 104 do not require a grounded conducted in one embodiment.

Most homes utilize AC power. Thus, to provide power to low voltage DC power, an AC/DC converter is utilized. In one embodiment the conversion takes place outside of the water. Thus, rather than converting from AC to DC in the housing, for example, the conversion takes place outside of the water such that only the low voltage DC is supplied to the lights. As noted, this is a significant safety advantage.

FIG. 4 is a perspective view of the converter and controller in one embodiment. As can be seen, the converter 108 is placed on a wall of the house. The AC power is converted to low voltage DC at the converter. The wire 103 then carries the low voltage DC power to the light 104. The converter 108 can comprise virtually any converter known in the art which can convert to the desired voltages. The converter 108 can be housed or stored in any desirable location. The converter 108 can also comprise a transformer. In one embodiment the transformer is a 110 to 12V transformer.

Also depicted is the controller 109. The controller communicates with and controls the lights 104. The controller 109 sets which lights are on, when they come on, what color they are, pattern, dimming, etc. The controller 109 can set the pool lights to flash and coincide with music. As shown, the controller 109 is housed adjacent to the converter 108. Thus, in one embodiment, the controller 109 and the converter 108 are not stored in the water. The only electronics on the light which are in the water are 1) the light 104 itself, and 2) the wire 103 which brings low voltage DC power to the light 104. The controller 109 couples to the converter/transformer 108 and the assembly 100.

Various types of controllers 109 can be utilized. In one embodiment the controller 109 can communicate with other wireless devices via WiFi, Bluetooth, etc. This allows remote devices to control the controller 109. In one embodiment the controller 109 comprises a unique identifier such as a bar code, QR code, or the like. A user can scan the unique identifier with a device such as a smart phone, tablet, etc. This will couple the controller 109 with the user's device and allow the user to control the controller 109.

Now that the system has been described, a method of installing and utilizing the system will be described.

First, the existing light, if one exists, is removed. The housing and the light are removed. In one embodiment the existing wire 103 can be decoupled from the light and reused. In one embodiment the existing light housing has an outer diameter of 10 and ⅛^{th} inches. This is a pool light size which is common in the industry. The existing pool light can be removed and the planar plate 101 will take its place. The size and shape of planar plates 101 can vary. While a circular shape is shown, this is for illustrative purposes only and should not be deemed limiting. Other shapes including squares, rectangles, etc. can also be utilized.

Next, a wire 103, either a new wire or the previously used wire, is inserted through the niche 102. The wire 103 is electrically coupled to the new light 104. This electrical coupling can take any form known in the art.

After the wire 103 is coupled to the new light 104, the light 104 is coupled to the assembly. As noted, in one embodiment the coupling is via threading. As shown the light 104 comprises a stem 105 which threadlingly engages with the stem receiver 106. In other embodiments it can be the opposite, specifically the light 104 can comprise a stem receiver 106 and the stem 105 is located on the niche 102.

Once the wire 103 is coupled to the light 104, the assembly 100 is placed within the recess of the pool or other structure. The assembly 100 can be coupled to the pool via any method or device known in the art. As noted, in one embodiment the plate 101 comprises coupling holes 109 through which a screw or bolt can be inserted to couple to the pool. In one embodiment the snap 110 engages with the pool niche and screws or the like engage the pool through the coupling holes 109.

The above process can be repeated for each light in the structure. This completes the installation of the actual assembly 100. In some embodiments the electrical system supplying power to the lights needs to be modified to provide DC power rather than AC power.

In one embodiment to modify the electrical system, a converter 107 is installed in electrical line which powers the lights 104. This ensures that only low voltage DC power is supplied to the lights. Further, the controller 108 can be installed allowing the user to remotely control the lights 104.

As noted, the system and method have many benefits. First, the system provides an opportunity to replace existing lights with LED lights. As noted, the LED lights offer many benefits which are not possible with the prior art lights. These include color changing, patterns, etc. A user now has the capability to safely and easily convert the old lights for updated LED lights.

A second benefit is the conversion to DC power. AC power, in water, is comparatively more dangerous than DC power. Consequently, removing AC power from the pool, for example, and replacing it with low voltage DC power results in a safer solution. Other AC solutions had to account for stray currents which could harm swimmers. That is not a concern with low voltage DC power.

A third benefit which arises from the low voltage DC conversion is the reduction in power consumption. The prior incandescent lights consumed large amounts of electrical energy and wasted much of that energy as heat. Conversely, an LED light uses very little energy. Thus, power consumption is reduced.

A fourth benefit is the ability to incorporate a newer and powerful controller. Often the prior art light systems only included a light switch. However, by modifying the system to include a new controller, the user can control all aspects of the light. This includes timing, color, patterns, etc.

A fifth benefit is the elimination of the housing. As noted, previously the housing was required to house and display the light. The system allows the housing to be removed.

A sixth benefit is the ability to easily replace the LED light. As noted, the light simply couples to the wire 103 and then couples to the assembly 100. If an LED becomes damaged, or if the user wants to replace the LED for any reason, that can easily be accomplished.

While the invention has been particularly shown and described with reference to a preferred embodiment, it will be understood by those skilled in the art that various changes in form and detail may be made therein without departing from the spirit and scope of the invention.

What is claimed is:

1. A system for a light, said system comprising:
a planar plate;
a niche coupled to said plate.

2. The system of claim 1 wherein said system further comprises a wire and a light, wherein light couples to said niche.

3. The system of claim 2 wherein said niche comprises a stem receiver, and wherein said light comprises a stem which couples with said stem receiver, and wherein said light comprises an LED.

4. The system of claim 2 wherein said wire is coupled to a converter which converts AC into DC and delivers DC voltage to said light.

5. The system of claim 4 wherein planar plate and said light is coupled to a wall in a body of water, and wherein said converter is located outside of said body of water.

6. The system of claim 3 wherein said light and said planar plate do not comprise a housing.

7. The system of claim 4 further comprising a controller.

8. The system of claim 4 wherein said converter is a transformer.

9. The system of claim 7 wherein said controller is remotely coupled to a device.

10. The system of claim 7 wherein said controller has a unique identifier which is scanned by said device.

11. The system of claim 1 wherein said planar plate comprises a clip and at least one coupling hole.

12. The system of claim 1 wherein said planar plate and niche comprise a kit to replace existing pool lights.

13. A method of replacing lights, said method comprising:
a) removing existing lights;
b) coupling a planar plate to an existing niche;
c) coupling a light to said planar plate.

14. The method of claim 13 wherein said coupling of step b) comprises coupling a clip from said planar plate with an existing niche and attaching a coupler through at least one coupling hole located on said planar plate.

15. The method of claim 13 wherein said coupling comprises coupling an LED light to a niche on said planar plate.

16. The method of claim 13 wherein said light is coupled to a wire, and coupling said wire to a converter.

17. The method of claim 16 wherein said converter converts AC to DC voltage.

18. The method of claim 16 further comprising coupling said converter to a controller, and wherein said controller controls said light.

19. The method of claim 16 further comprising the step of connecting said controller to a smart device.

20. The system of claim 1 wherein said light is powered with DC.
